(19) United States
(12) Patent Application Publication
(10) Pub. No.: US 2016/0036812 A1
(43) Pub. Date: Feb. 4, 2016

(54) Database Queries Integrity and External Security Mechanisms in Database Forensic Examinations

(71) Applicant: International Business Machines Corporation, Armonk, NY (US)

(72) Inventor: Leonid Rodniansky, Allston, MA (US)

(73) Assignee: International Business Machines Corporation, Armonk, NY (US)

(21) Appl. No.: 14/448,286

(22) Filed: Jul. 31, 2014

(51) Int. Cl. H04L 29/06; G06F 17/30

(52) U.S. Cl. CPC H04L 63/0876; G06F 17/30864; G06F 17/30371

(57) ABSTRACT

A method, system and computer-usable medium are disclosed for performing forensic database security operations to verify database query integrity. A database protocol packet is intercepted, inspected and then processed by an external database security mechanism (EDSM) system to extract a database query. The database query is then processed with a secret key to generate a first keyed-hash message authentication code (HMAC) value, which is then inserted into the intercepted database protocol packet according to database protocol rules to generate a modified database protocol packet in a way that HMAC values and database query will be stored in predetermined database server session tracking tables. The modified database protocol packet is then provided to a database server, where database server subsequently accessed by the EDSM system to retrieve the database query and the first HMAC value. The EDSM system then uses the same secret key to calculate a second HMAC value for the retrieved database query, which is compared to the first HMAC value to determine whether they match. If not, then the database query is marked as having been modified after being inspected by the EDSM system.

### BACKGROUND OF THE INVENTION

1. Field of the Invention

The present invention relates in general to the field of computers and similar technologies, and in particular to software utilized in this field. Still more particularly, it relates to a method, system and computer-usable medium for performing forensic database security operations to verify database query integrity.

2. Description of the Related Art

It is common for businesses, organizations and individuals alike to store data in various types of databases. Examples of such databases include relational databases, object-oriented databases, graph databases, and network databases. These databases are generally managed through the implementation of a database management system (DBMS), which is a software application that interacts with the user, other applications, and the database itself to receive, store, process and provide data. As such, a general-purpose DBMS allows the definition, creation, querying, update, and administration of databases. Known DBMSs include Microsoft® SQL Server® and Microsoft® Access, available from Microsoft Corporation of Redmond, Wash., Oracle®, available from Oracle Corporation of Redwood City, Calif., and DB2®, available from International Business Machines (IBM®) of Armonk, N.Y. A database is not generally portable across different DBMSs, but different DBMSs can interoperate by using standards such as Structured Query Language (SQL), Open Database Connectivity (ODBC), or Java Database Connectivity (JDBC) to allow a single application to work with more than one database.

Ensuring the security of data stored in various databases is becoming increasingly important. Potential threats to database security include unauthorized users or hackers inappropriately accessing, and possibly misusing, sensitive data, metadata or functions contained within a database. Such inappropriate access and misuse may also be perpetrated by authorized database users, database administrators, network managers, or system administrators. Other threats include malware infections, which may cause incidents such as unauthorized access, leakage or disclosure of personal or proprietary data, and deletion of, or damage to, data or applications programs. Malware infections may also cause interruption or denial of authorized access to the database, attacks on other systems, and the unanticipated failure of database services. Likewise, overloads, performance constraints, and capacity issues may result in the inability of authorized users to use databases as intended.

As a result, database security may involve the use of a broad range of information security controls, not only to protect the data itself, but also related database applications and stored functions. One known approach to securing data stored in a database is encryption of the data stored in a database. Another approach is the implementation of user identifier (UID) and password authentication to allow access to the data, whether it is encrypted or not. Yet another approach involves the implementation of various crypto security mechanisms, such as a Public Key Infrastructure (PKI). Still other approaches may involve the implementation of an external database security mechanism (EDSM) system, which intercepts and analyzes data traffic between a database client and a database server. However, such EDSM system approaches may not be able to monitor every entry to database server. Furthermore, a query may be modified, inside or outside of the database server, by a malicious program subsequent to its verification.

### SUMMARY OF THE INVENTION

A method, system and computer-usable medium are disclosed for performing forensic database security operations to verify database query integrity. In various embodiments, monitoring operations are performed to detect the presence of a database protocol packet. Once detected, it is intercepted and provided to an external database security mechanism (EDSM) system, where it is inspected and verified. Once the intercepted database protocol packet has been inspected and verified, it is then processed to extract an associated database query.

The EDSM then processes the extracted database query with a secret key to generate a first keyed-hash message authentication code (HMAC) value, which in turn is inserted into the intercepted database protocol packet according to database protocol rules to generate a modified database protocol packet in a way that HMAC values and database query will be stored in predetermined database server session tracking tables. In various embodiments, the database query is not affected in the generation of the modified data packet. The modified database protocol packet is then provided to a target database server, where certain data it contains is stored in predetermined database server session tracking tables.

Forensic database security operations are then begun by the EDSM system selecting a target database server. Once selected, the EDSM system then accesses predetermined database server session tracking tables associated with the selected target database server to retrieve the database query and the first HMAC value. In various embodiments, the database query and the first HMAC value is retrieved through the use of predetermined database connection. The EDSM system then uses the same secret key to calculate a second HMAC value for the database query. The second HMAC value is then compared to the first HMAC value stored in the database session tracking tables to determine whether the two HMAC values match. If not, then the database query is marked as having been modified after being inspected and verified by the EDSM system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of an external database security mechanism (EDSM) system;

FIG. 3 is a simplified block diagram of an EDSM system being circumvented;

FIGS. 4a and 4b show the generation of an keyed-hash message authentication code (HMAC) value associated with a database query and corresponding insertion thereof into an associated exemplary Oracle database protocol packet;

FIG. 5 is a generalized flowchart of the performance of database query HMAC generation operations; and

FIG. 6 is a generalized flowchart of the performance of forensic database security operations.

### DETAILED DESCRIPTION

A method, system and computer-usable medium are disclosed for performing forensic database security operations to verify database query integrity. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

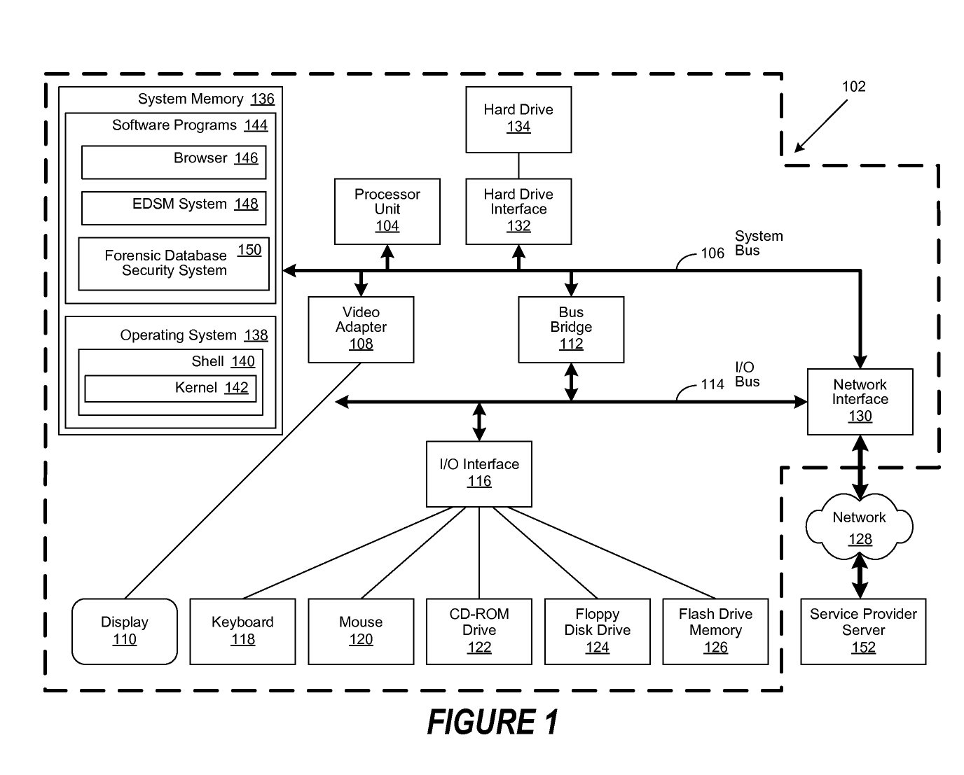

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 may include a browser. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. In various embodiments, software programs 144 may also include an external database security mechanism (EDSM) system 148 and a forensic database security system 150. In these and other embodiments, the EDSM system 148 and the forensic database security system 150 includes code for implementing the processes described herein below. In one embodiment, client computer 102 is able to download the EDSM system 148 and the forensic database security system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit, scope and intent of the present invention.

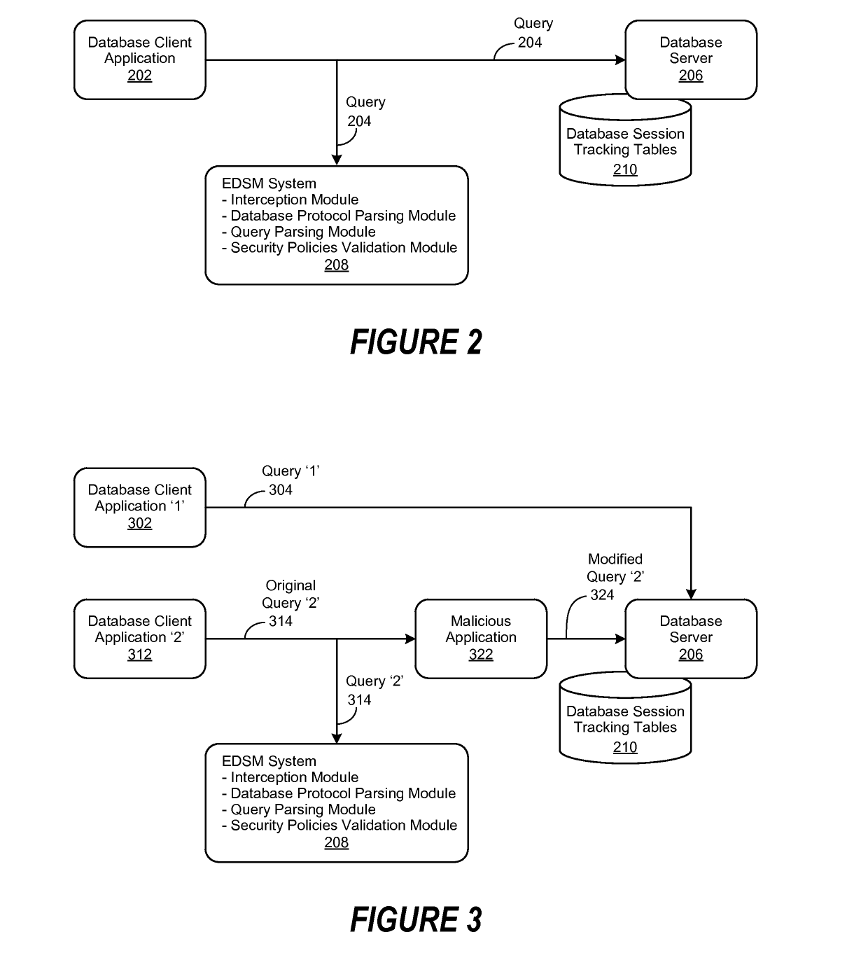

FIG. 2 is a simplified block diagram of an external database security mechanism (EDSM) system implemented in accordance with an embodiment of the invention. Skilled practitioners of the art will be aware that it is common for many organizations protect sensitive information stored in a database through the implementation of an EDSM system 208, which intercepts and analyzes data traffic, such as a database query 204, between a database client application 202 and a database server 206. In various embodiments, the database server 206 stores data associated with one of more database queries 204 in a repository of database session tracking tables 210.

In these and other embodiments, the EDSM system 208 may include an interception module, a database protocol parsing module, a query parsing module, a security policies validation module, or any combination thereof. In various embodiments, the EDSM system 208 is implemented to parse the database query 204 to a database object level. Once individual database objects are parsed, they are then validated against predetermined EDSM system security policies to identify possible database object access violations. If an access violation is detected, then an alert is generated by the EDSM system 208. The method by which a database access violation is identified and an associated alert is generated is a matter of design choice.

One example of such an EDSM system 208 is Infosphere Guardium®, available from International Business Machines (IBM®). In various embodiments, the EDSM system 208 is implemented to monitor and audit compliance control. In these and other embodiments, the EDSM system 208 may likewise be implemented to protect against internal or external threats by preventing unauthorized data access and providing alerts on changes to predetermined data to help ensure data integrity. In certain embodiments, the EDSM system 208 may be implemented to monitor and audit data activity associated with predetermined processing platforms and data access protocols. Likewise, the EDSM system 208 may be implemented in various embodiments to enforce predetermined security policies in real-time for various data access, change control, and user activities. In certain embodiments, the EDSM system 208 is implemented to provide a centralized repository of audit data, which can be used in support of various organization compliance, reporting and database forensic activities.

Skilled practitioners of the art will be aware that one advantage of an EDSM system 208 is its ability to maintain Separation of Duties (SoD), which embodies the concept of requiring more than one person to complete a task. As it relates to typical business operations, the separation by sharing a given task by more than one individual is an internal control approach intended to prevent fraud and error. This concept is also known as segregation of duties, or in the political realm, separation of powers.

As it relates to technical systems and information technology, the concept of SoD is generally addressed as being equivalent to redundancy. In particular, SoD is a known approach for securing data from privileged database users, such as a database administrator (DBA). However, it will be appreciated that a DBA is typically granted significant database access and management rights. As a result, the integrity of a database may be at risk due to malicious actions performed by an unscrupulous DBA.

FIG. 3 is a simplified block diagram of an external database security mechanism (EDSM) system implemented in accordance with an embodiment of the invention being circumvented. Those of skill in the art will realize that the data protection typically provided by an EDSM system 208 may be circumvented. For example, as shown in FIG. 3, the database client application ‘1’ 302 may submit a database query ‘1’ 304 directly to the database server 206. In this example, the database query ‘1’ 304 is not intercepted by the EDSM system 208. As a result, it is bypassed and the data protection it provides is circumvented.

As another example, the database client application 312 may submit a database query ‘2’ 314 to the database server 206. In this example, the original database query ‘2’ 314 is intercepted by the EDSM system 208 and verified prior to being submitted to the database server 206. However, as shown in FIG. 3, the original database query ‘2’ 314 is then subsequently intercepted by a malicious application 322, which processes it to generate a modified database query ‘2’, which is then submitted to the database server 206. As a result, the data protection provided by the EDSM system 208 is circumvented, despite the fact that the original database query ‘2’ 314 had previously been verified by the EDSM system 208. Skilled practitioners of the art will realize that many such examples are possible, and the foregoing is not intended to limit the spirit, scope or intent of the invention.

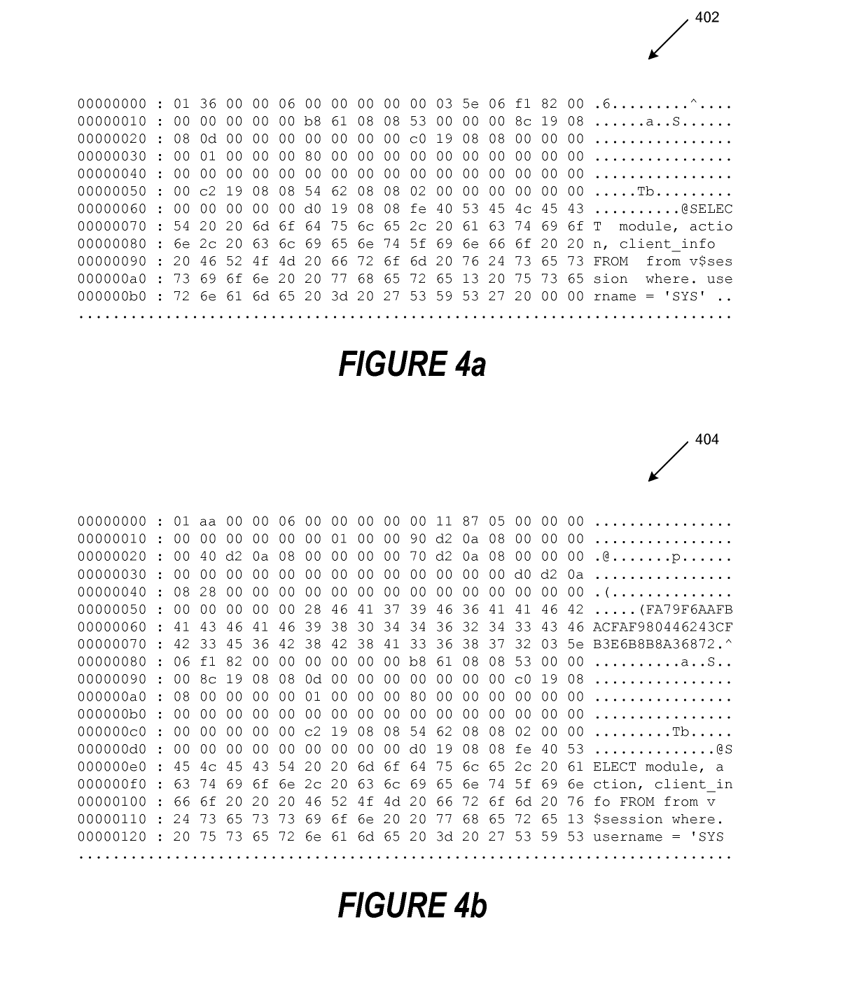

FIGS. 4a and 4b show the generation of an keyed-hash message authentication code (HMAC) value associated with a database query and corresponding insertion thereof into an associated exemplary Oracle database protocol packet implemented in accordance with an embodiment of the invention. Skilled practitioners of the art will be aware that contemporary databases typically have various capabilities to track database session activity, manipulate data within a database, and analyze related metadata. For example, a DB2® database permits an application to set client information, by setting the fields in the sqle_client_info_data structure, that is associated with a specific connection, provided a connection already exists.

By using a predetermined Application Program Interface (API), the database client can pass the client's user ID, workstation information, program information, and other accounting information to the database server. While these capabilities may be advantageously used for general forensic examination of database metadata, they are insufficient for determining whether a data query has been modified, maliciously or otherwise, after it has been verified by an external database security mechanism (EDSM) system.

In various embodiments, monitoring operations are performed to detect the presence of a database protocol packet 402. Once detected, it is intercepted and provided to an EDSM system, where it is inspected and verified as described in greater detail herein. The method by which the database protocol packet is detected, intercepted and then provided to the EDSM is a matter f design choice.

Once the intercepted database protocol packet has been inspected and verified, it is then processed to extract an associated database query. For example, as shown in FIG. 4a, the database protocol packet 402 contains the following database query:

```
        SELECT module, action, client_info FROM from
        v$session
where username = ‘SYS’
```

Once extracted, the EDSM then processes the database query with a secret key to generate a corresponding HMAC value. As shown in FIG. 4b, use of a secret key, such as 8b58TX3jq9x9, results in an HMAC value of FA79F6AAFBACFAF980446243CFB3E6B8B8A36872.

Skilled practitioners of the art will be aware that an HMAC is a predetermined construction for calculating a message authentication code (MAC) involving a cryptographic hash function in combination with a secret cryptographic key. As such, it may be used to simultaneously verify both the data integrity and the authentication of a message, such as a database query. In various embodiments, any cryptographic hash function, such as MD5 or SHA-1, may be used in the calculation of an HMAC. Those of skill in the art will likewise be aware that the cryptographic strength of the HMAC depends upon the cryptographic strength of the underlying hash function, the size of its hash output, and on the size and quality of the key.

The resulting HMAC value is then inserted into the intercepted database packet 402 shown in FIG. 4a to generate according to database protocol rules the modified data packet value 404 shown in FIG. 4b. The method by which the HMAC value is inserted into the intercepted database packet 402 to generate the modified database packet 404 is based upon the database protocol. In various embodiments, the database query is not affected in the generation of the modified data packet. The modified database packet 404 is then provided to a target database server. Thereafter, the database server stores data contained in the modified database packet 404 in predetermined database server session tracking tables. The method by which the database server stores data contained in the modified database packet in the predetermined database server session tracking tables is based upon the database server.

In various embodiments, forensic database security operations are begun by an EDSM system selecting a target database server. Once selected, the EDSM system then accesses predetermined database server session tracking tables associated with the selected target database server, followed by retrieving a target database query and its associated HMAC value. As an example, the EDSM may use an Oracle® dynamic view, such as:

```
        SELECT SS.CLIENT_INFO, AR.SQL_fullTEXT SQL
FROM V$SQLAREA AR, V$SESSION SS
        WHERE SS.SQL_ADDRESS = AR.ADDRESS AND
SS.SQL_HASH_VALUE = AR.HASH_VALUE
```

Which results in:

```
        CLIENT_INFO :
        FA79F6AAFBACFAF980446243CFB3E6B8B8A36872
        SQL: SELECT module, action,
        client_info FROM from v$session
where username = ‘SYS’
```

A determination is then made whether the HMAC value (e.g., FA79F6AAFBACFAF980446243CFB3E6B8B8A36872) associated with the target database query is present. If not, then the target database query is marked as not having been initially verified by the EDSM system. However, if the HMAC value associated with the target database query is present, then the EDSM system uses the same secret key (e.g., 8b58TX3jq9x9), as described in greater detail herein, to calculate the HMAC value of the target database query. The resulting HMAC value is then compared to the corresponding HMAC value stored in the database session tracking tables to determine whether the two HMAC values match. If not, then the target database query is marked as having been modified after being inspected and verified by the EDSM system.

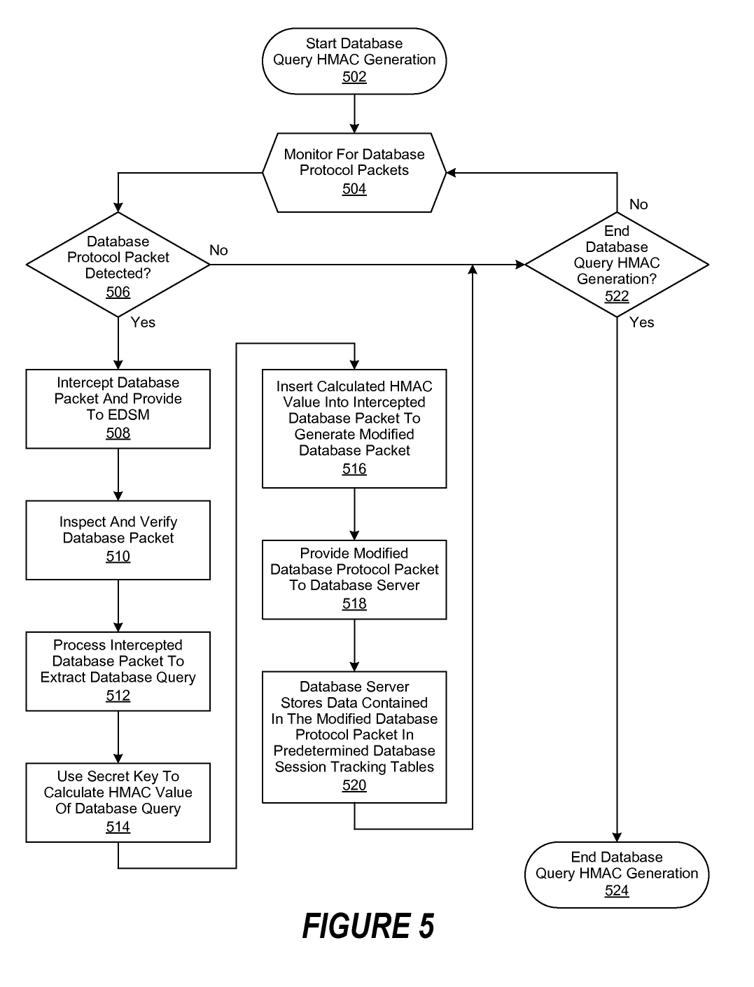

FIG. 5 is a generalized flowchart of the performance of database query keyed-hash message authentication code (HMAC) generation operations in accordance with an embodiment of the invention. In this embodiment, database query HMAC generation operations are begun in step 502, followed by the ongoing performance of monitoring operations in step 504 to detect the presence of database protocol packets. A determination is then made in step 506 whether a database protocol packet has been detected. If not, then a determination is made in step 522 whether to end database query HMAC generation operations. If not, then the process is continued, proceeding with step 504. Otherwise, database query HMAC generation operations are ended in step 524.

However, if it is determined in step 506 that a database protocol packet has been detected, then the detected database protocol packet is intercepted and provided in step 508 to an external database security mechanism (EDSM) system. The intercepted database protocol packet is then inspected and verified in step 510, as described in greater detail herein, by the EDSM. Once the intercepted database protocol packet has been inspected and verified, it is then processed in step 512 to extract an associated database query. In turn, the extracted database query is processed with a secret key in step 514 to generate a corresponding keyed-hash message authentication code (HMAC) value.

Skilled practitioners of the art will be aware that an HMAC is a predetermined construction for calculating a message authentication code (MAC) involving a cryptographic hash function in combination with a secret cryptographic key. As such, it may be used to simultaneously verify both the data integrity and the authentication of a message, such as a database query. In various embodiments, any cryptographic hash function, such as MD5 or SHA-1, may be used in the calculation of an HMAC. Those of skill in the art will likewise be aware that the cryptographic strength of the HMAC depends upon the cryptographic strength of the underlying hash function, the size of its hash output, and on the size and quality of the key.

The EDSM system then inserts the HMAC value of the database query into the intercepted database protocol packet in step 516 to generate a modified database protocol packet. The method by which the HMAC value is inserted into the intercepted database packet (in a way that HMAC values and database query will be stored in predetermined database server session tracking tables) to generate the modified database packet is based upon database protocol. The modified database protocol packet is then provided to a target database server in step 518. Then, in step 520, the database server stores data contained in the modified database packet in predetermined database server session tracking tables and the process is continued, proceeding with step 522. The method by which the database server stores data contained in the modified database packet in predetermined database server session tracking tables is based upon database server.

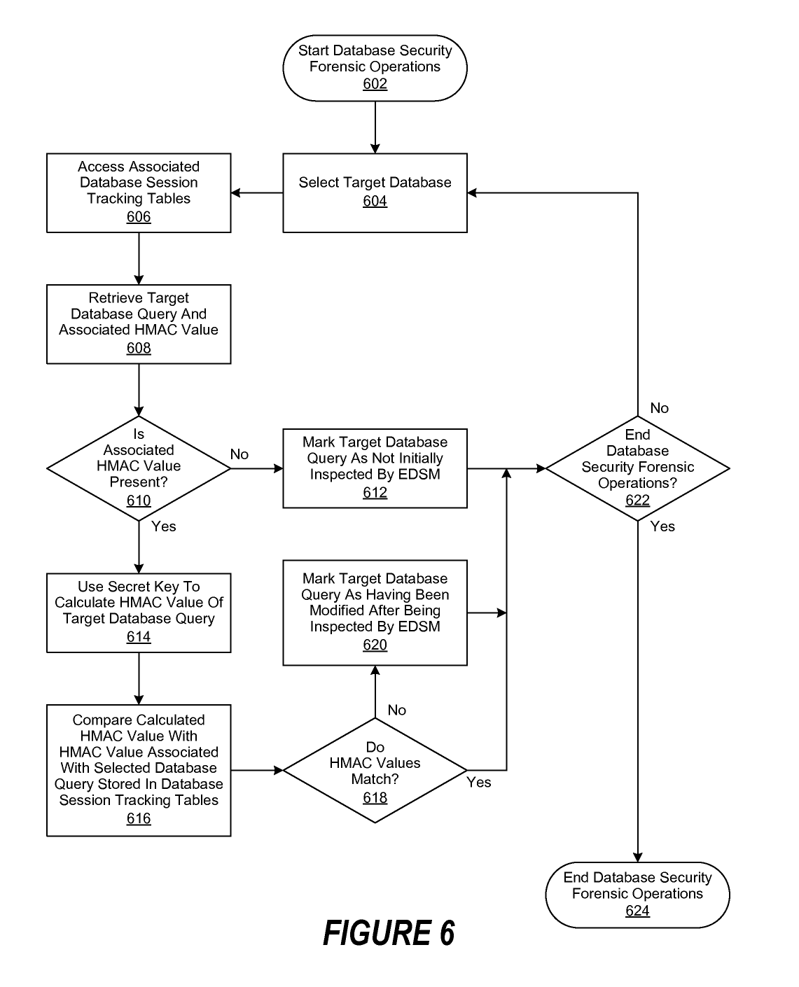

FIG. 6 is a generalized flowchart of the performance of forensic database security operations implemented in accordance with an embodiment of the invention. In this embodiment, forensic database security operations are begun in step 602, followed by the selection of a target database in step 604 by an external database security mechanism (EDSM) system. The EDSM system then accesses predetermined database server session tracking tables associated with the selected target database server in step 606, followed by retrieving a target database query and its associated HMAC value in step 608. In various embodiments, the target database query and its associated HMAC value is retrieved through the use of predetermined database protocols familiar to those of skill in the art.

A determination is then made in step 610 whether the HMAC value associated with the target database query is present. If not, then the target database query is marked in step 612 as not having been initially inspected and verified by the EDSM system. A determination is then made in step 622 whether to end forensic database security operations. If not, then the process is continued, proceeding with step 604. Otherwise, forensic database security operations are ended in step 624.

However, if it was determined in step 610 that the HMAC value associated with the target database query is present, then the EDSM system uses the same secret key in step 614, as described in greater detail herein, to calculate the HMAC value of the target database query. The resulting HMAC value is then compared in step 616 to the corresponding HMAC value that is stored in the database session tracking tables. A determination is then made in step 618 whether the two HMAC values match. If not, then the target database query is marked in step 620 as having been modified after being inspected and verified by the EDSM. Thereafter, of if it was determined in step 618 that the two HMAC values match, the process is continued, proceeding with step 622. Otherwise, the process is continued, proceeding with step 620.

Although the present invention has been described in detail, it should be understood that various changes, substitutions and alterations can be made hereto without departing from the spirit and scope of the invention as defined by the appended claims.

1-6. (canceled)

7. A system comprising:
a hardware processor;
a data bus coupled to the hardware processor; and
a computer-usable medium embodying computer program code, the computer-usable medium being coupled to the data bus, the computer program code used for performing forensic database security operations to verify database query integrity and comprising instructions executable by the hardware processor and configured for:
intercepting a database protocol packet directed to a database server;
providing the intercepted database protocol packet to an external database security mechanism (EDSM) system;
inspecting the database protocol packet by the EDSM system, the database protocol packet comprising a database query;
using a secret key to calculate a first hash message authentication code (HMAC) for the database query;
inserting the first HMAC into the intercepted database protocol packet to generate a modified database protocol packet;
providing the modified database protocol packet to the database server; and
querying the database server for the first HMAC to verify that the EDSM system inspected the database protocol packet.

8. The system of claim 7, further comprising:
extracting the database query from the database protocol packet, wherein the first HMAC is calculated for the extracted database query portion of the database protocol packet.

9. The system of claim 7, wherein:
the database query is not affected in the generation of the modified database protocol packet.

10. The system of claim 8, further comprising:
storing the database query and the first HMAC in a database session tracking table associated with the database, wherein the database query and first HMAC can be accessed using a database protocol.

11. The system of claim 10, further comprising:
querying the database server to retrieve the database query and the first HMAC, the querying directed to the database session tracking table;
using the secret key to calculate a second HMAC for the database query; and
comparing the first HMAC to the second HMAC to verify that the database query has not been modified after being inspected by the EDSM system.

12. The system of claim 11, further comprising:
marking the database query as having been modified after being inspected by the EDSM system if the first HMAC and the second HMAC do not match.

13. A non-transitory, computer-readable storage medium embodying computer program code, the computer program code comprising computer executable instructions configured for:
intercepting a database protocol packet directed to a database;
providing the intercepted database protocol packet to an external database security mechanism (EDSM) system;
inspecting the database protocol packet by the EDSM system, the database protocol packet comprising a database query;
using a secret key to calculate a first hash message authentication code (HMAC) for the database query;
inserting the first HMAC into the intercepted database protocol packet to generate a modified packet;
providing the modified database protocol packet to the database server; and
querying the database server for the first HMAC to verify that the EDSM system inspected the database protocol packet.

14. The non-transitory, computer-readable storage medium of claim 13, further comprising:
extracting the database query from the database packet, wherein the first HMAC is calculated for the extracted database query portion of the database packet.

15. The non-transitory, computer-readable storage medium of claim 13, wherein:
the database query is not affected in the generation of the modified database packet.

16. The non-transitory, computer-readable storage medium of claim 14, further comprising:
storing the database query and the first HMAC in a database session tracking table associated with the database, wherein the database query and first HMAC can be accessed using a database protocol.

17. The non-transitory, computer-readable storage medium of claim 16, further comprising:
querying the database to retrieve the database query and the first HMAC, the querying directed to the database session tracking table;
using the secret key to calculate a second HMAC for the database query; and
comparing the first HMAC to the second HMAC to verify that the database query has not been modified after being inspected by the EDSM system.

18. The non-transitory, computer-readable storage medium of claim 17, further comprising:
marking the database query as having been modified after being inspected by the EDSM system if the first HMAC and the second HMAC do not match.

19. The non-transitory, computer-readable storage medium of claim 13, wherein the computer executable instructions are deployable to a client system from a server system at a remote location.

20. The non-transitory, computer-readable storage medium of claim 13, wherein the computer executable instructions are provided by a service provider to a user on an on-demand basis.
